(19) United States
(12) Patent Application Publication
(10) Pub. No.: US 2014/0038527 A1
(43) Pub. Date: Feb. 6, 2014

(54) Car A/V System for Wireless Communication

(71) Applicant: Shih-Yao CHEN, New Taipei City (TW)

(72) Inventor: Shih-Yao CHEN, New Taipei City (TW)

(21) Appl. No.: 13/568,066

(22) Filed: Aug. 6, 2012

(51) Int. Cl. H04W 4/00

(52) U.S. Cl. 455/41.3

(57) ABSTRACT

A car A/V system for wireless communication application includes a head unit consisting of a first wireless communication module and a multimedia processing device and installed in a car, a smart phone, and a speaker system. The touch panel of the smart phone is operable to generate a command for transmission to the multimedia processing device of the head unit to run a predetermined audio/video data, enabling the processed video data to be transmitted to the smart phone wirelessly for display on the display of the smart phone and the processed audio data to be transmitted to the speaker system for output.

### BACKGROUND OF THE INVENTION

1. Field of the Invention

The present invention relates to car A/V systems and more particularly, to a car A/V system for wireless communication application, which enables a smart phone to be used as a normal smart phone, or selectively attached to a car stereo head unit to work as a touch-control operation terminal of the car stereo head unit.

2. Description of the Related Art

A car generally has an A/V (audio/video) playback system installed therein for audio/video data playing application. A car A/V playback system generally comprises a head unit, and one or multiple display panels electrically connected to the head unit by a cable for receiving analog A/V signals such as NTSC or PAL from the head unit for output.

Because a vehicle A/V (audio/video) playback system requires a complicated wiring, its installation is time-consuming. Taiwan Patent 1271333 discloses a vehicle A/V playback system entitled “Wireless vehicle A/V system and method”. According to this design, the wireless vehicle A/V system comprises a head unit providing a storage device having stored therein at least one digital A/V file and a wireless network interface, and display means, which comprises a wireless network interface and a display panel. The display panel is connectable to the head unit wirelessly through the wireless network interface for receiving digital audio files from the head unit and playing back the files.

The aforesaid prior art design is a one-to-one system, and therefore the application of the aforesaid prior art design is limited. Further, the installation of the aforesaid prior art design and the related devices and the operation control of the aforesaid prior art design are complicated.

### SUMMARY OF THE INVENTION

The present invention has been accomplished under the circumstances in view. It is one object of the present invention to provide a car A/V system for wireless communication application for use in a car, which enables a smart phone to be used as a normal smart phone, or selectively attached to a car stereo head unit to work as a touch-control operation terminal of the car stereo head unit.

To achieve this and other objects of the present invention, a car A/V system for wireless communication application, comprises a head unit, at least one smart phone, and a speaker system. The head unit is installed in a car comprising a vehicle control computer system. The head unit is electrically connected to the vehicle control computer system through a CAN-bus for transmitting audio and video data therebetween, comprising a first wireless communication module and a multimedia processing device. The multimedia processing device is adapted to process audio and video data from different sources. Each smart phone comprises a display means, and a second wireless communication module for communication with the first wireless communication module wirelessly. The display means comprises a touch panel. The speaker system is installed in the car and electrically connected to said head unit. The touch panel of each smart phone is operable to generate a command that can be transmitted to the multimedia processing device of the head unit wirelessly through the second wireless communication module of the respective smart phone and the first wireless communication module of the head unit to run a predetermined audio/video data, enabling the video data to be transmitted to the respective smart phone wirelessly for display on the display means of the respective smart phone and the audio data to be transmitted to said speaker system for output.

Further, the second wireless communication module of each smart phone and the first wireless of the head unit are configured subject to Wi-Fi communication protocol. Further, the head unit and each smart phone can be configured for wireless communication subject to real-time transport protocol.

Further, the car A/V system for wireless communication application comprises a charger electrically connectable to each smart phone through a USB cable.

Further, the multimedia processing device can be configured to process audio/video files from CD, DVD, SD memory card and/or USB, DVB-T (Digital Video Broadcasting-Terrestrial) signals, or FM/AM broadcasting signals.

Further, the head unit can be equipped with a GPS sensor, a rear camera, a digital video recorder, and an AUX-in connector.

Further, the smart phone has a Bluetooth function for communication with an external Bluetooth device, and equipped with a GPS module and a 3.5G/4G wireless mobile phone and data transmission system for cloud computing based vehicle tracking and fleet management and dispatch management. The 3.5G/4G wireless mobile phone and data transmission system has built therein a GPS system.

Further, the head unit comprises a user interface disposed at an outer side thereof for operation by a user, a microcontroller unit, a video switch mixer electrically connected to the microcontroller unit, a volume switch control electrically connected to the microcontroller unit for controlling the speaker system, and a power management electrically connected to the microcontroller unit and adapted for obtaining power supply from a power supply system of the car.

The car A/V system for wireless communication application of the present invention employs a wireless signal to connect the head unit and the smart phone, eliminating complicated wiring and facilitating system installation. Further, the smart phone that is normally attached to the head unit can be carried out of the car by the user for use independently.

### BRIEF DESCRIPTION OF THE DRAWINGS

FIG. 1 is a schematic drawing illustrating the system architecture of a car A/V system for wireless communication application in accordance with the present invention.

FIG. 2 is a system block diagram of the car A/V system for wireless communication application in accordance with the present invention.

FIG. 3 is a schematic drawing of the present invention, illustrating a navigation function of the car A/V system for wireless communication application.

FIG. 4 is a schematic drawing of the present invention, illustrating the main control smart phone attached to the head unit in the car.

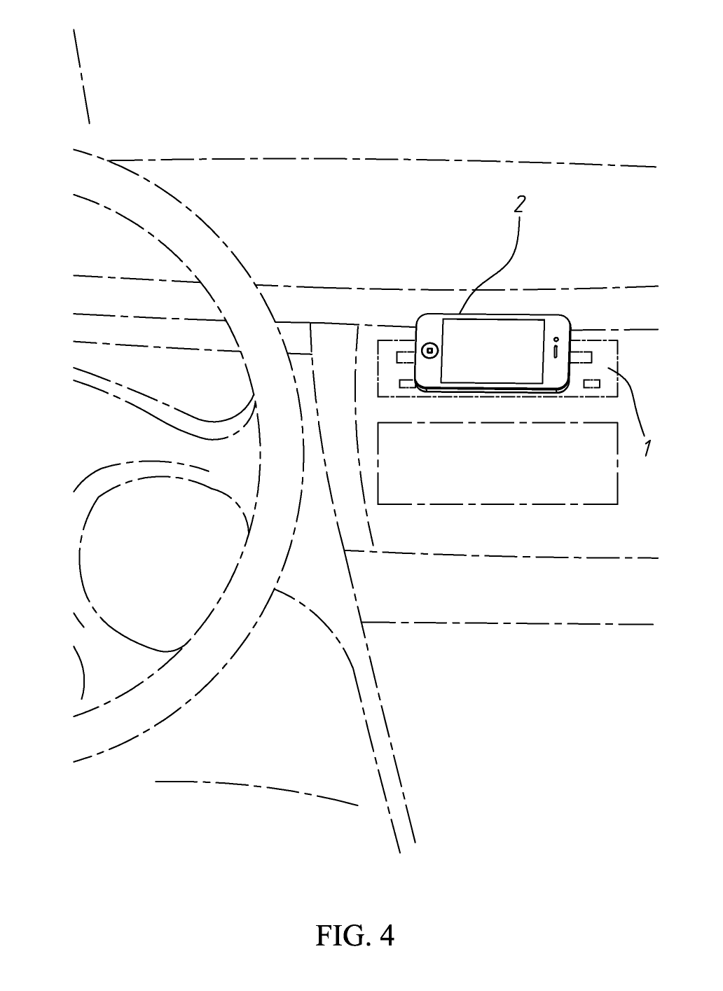

### DETAILED DESCRIPTION OF THE PREFERRED EMBODIMENT

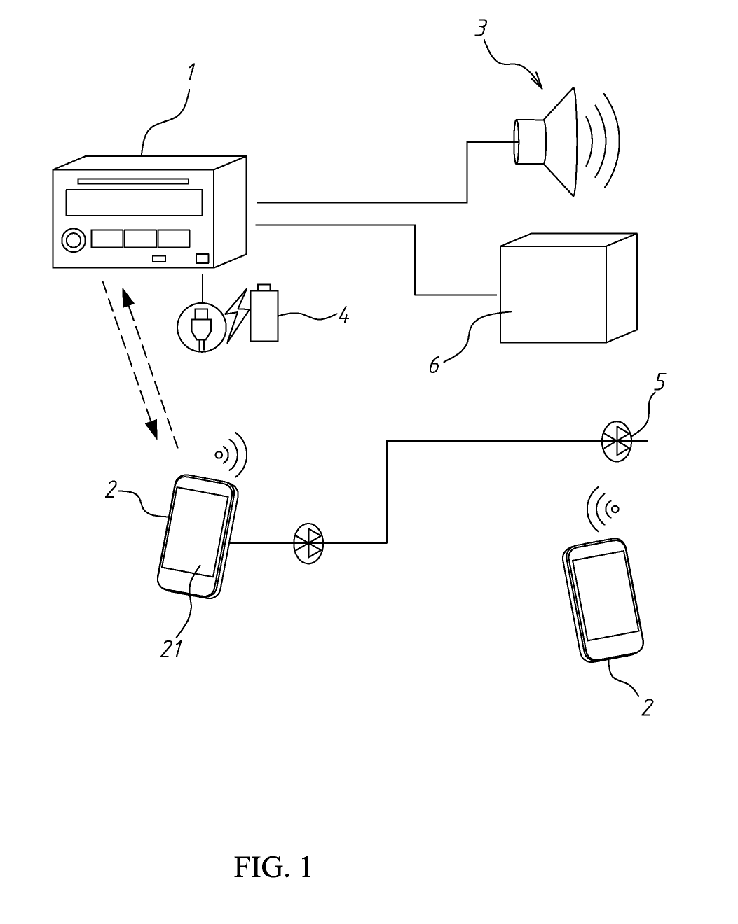

Referring to FIG. 1, a car A/V system for wireless communication application in accordance with the present invention is shown comprising a head unit 1, at least one smart phone (SP) 2, a speaker system 3, a charger 4, and a Bluetooth device 5. When one single smart phone 2 is used, the smart phone 2 can be directly attached to the head unit 1 to work as a car stereo display and touch operation terminal.

The car A/V system for wireless communication application is installed in a car, and electrically connected to the vehicle control computer system of the car by a CAN-bus 6. Vehicle control data signal from the vehicle control computer system is transmitted to the head unit 1 for format conversion, and then the converted data signal is provided by the head unit 1 to the smart phone 2 in a wireless manner for display or control. Through a Wi-fi transmission system, the head unit 1 can communicate with multiple smart phones 2, establishing an information sharing system.

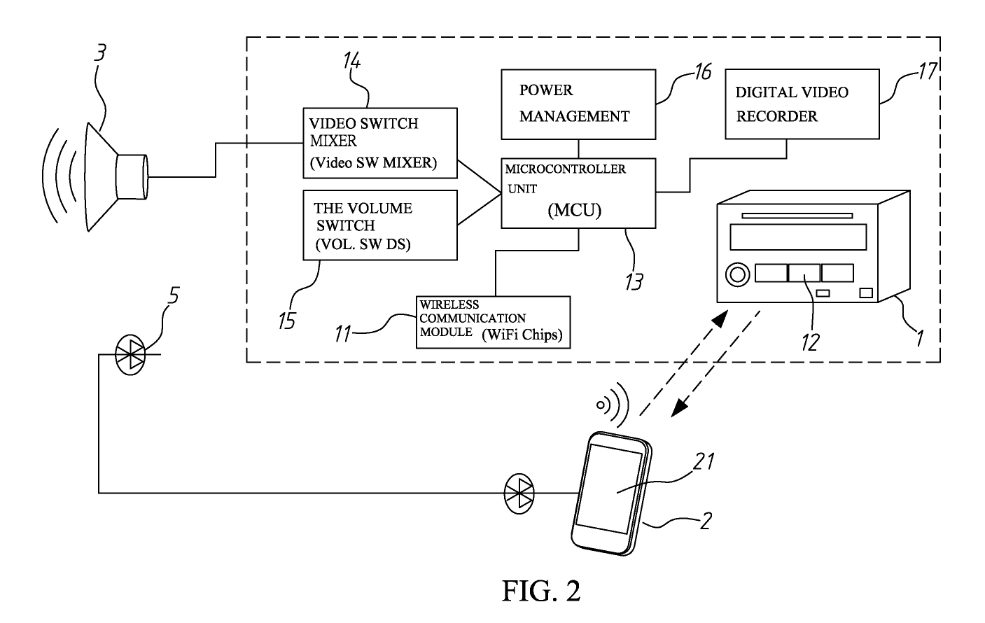

Referring to FIG. 2, the head unit 1 is installed in a car, comprising a first wireless communication module 11, and a multimedia processing device. The first wireless communication module 11 in this embodiment is a Wi-fi module. The multimedia processing device of the head unit 1 can process audio and video data from different sources, for example, audio/video files from CD, DVD, SD memory card or USB, DVB-T (Digital Video Broadcasting-Terrestrial) signals, or FM/AM broadcasting signals. The head unit 1 can also provide a GPS sensor, a rear camera, and/or an AUX-in connector.

Referring to FIG. 2 again, the head unit 1 further comprises a user interface 12 disposed on the outside thereof for effective operation and control of the car A/V system for wireless communication application, and feedback from the car A/V system for wireless communication application which aids the operator in making operational decisions. The user interface 12 includes buttons for volume control, radio frequency adjustment, or other functional controls. The head unit 1 further comprises a microcontroller unit 13 electrically connected to the first wireless communication module 11 and having built therein a control program, a video switch mixer 14, a volume switch 15, and a power management 16. The video switch mixer 14 is for video control. The volume switch 15 controls the speaker system 3 of the car A/V system for wireless communication application. The power management 16 obtains power supply from the power system of the car. Further, a digital video recorder 17 is electrically connected to the head unit 1.

Further, when multiple smart phones 2 are used, one of the smart phones 2 is selected and set to be the main control smart phone. The main control smart phone comprises a touch panel 21, a second wireless communication module connectable to the first wireless communication module 11 in the head unit 1 wirelessly and capable of transmitting audio/video data subject to real-time transport protocol. The speaker system 3 is installed in the car at a selected location, and electrically connected to the head unit 1. Further, the speaker system 3 can have a wireless transmission function.

Further, the touch panel 21 of the main control smart phone 2 is operable to generate a command for transmission wirelessly to the head unit 1, controlling the multimedia processing device to process one audio/video data. The processed video data is transmitted to the touch panel 21 of the main control smart phone 2 for display on the display screen thereof. The processed audio data is then transmitted to the speaker system 3 for output.

The smart phone 2 can be equipped with a 3.5G/4G wireless mobile phone and data transmission system for cloud computing based vehicle tracking and fleet management and dispatch management. This 3.5G/4G wireless mobile phone and data transmission system has built therein a GPS system. Through the 3.5G/4G wireless mobile phone and data transmission system and its built-in GPS system, the smart phone 2 can provide the traveling position and other related traveling data of the car to a remote control center for filing or other control considerations.

Further, the charger 4 is electrically connectable to the smart phone 2 through a USB cable to charge the internal battery of the smart phone 2.

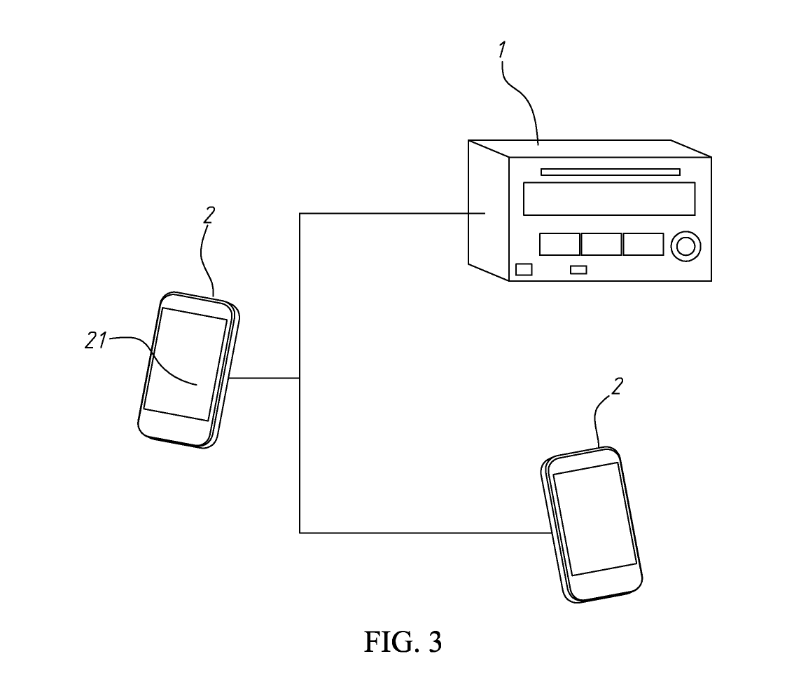

Further, the smart phone 2 has a Bluetooth function for communication with a Bluetooth device 5. Referring also to FIG. 3, the smart phone 2 has built therein a GPS module capable of using the internal GPS antenna module of the head unit 1 to provide a navigation function.

In the following table, various signal sources for different operation functions of the car A/V system for wireless communication application are illustrated:

| | Applications |
|---|---|
| SP→Command→Head Unit | DVD, digital TV |
| Head Unit→RTP (Video) →SP | |
| Head Unit→Command→SP, | Parking assist and |
| Head Unit→RTP (Video) →SP | other functions |
| SP→Command→Head Unit | FM/AM, CD playing |
| SP combines all music (including SP, Head | MP3 |
| Unit-USB/SD) | |
| 1. Play music in SP: | |
| SP→Command→Head Unit), | |
| SP→RTP (Audio)→Head Unit) | |
| 2. Play music in Head Unit: | |
| SP→Command→Head Unit | |
| SP combines all Videos (including SP, Head | Video |
| Unit-USB/SD) | |
| SP→Command→Head Unit | |
| Head Unit→RTP (Video) →SP | |
| SP→Command) → (Head Unit | GPS |
| SP→RTP (Audio) →Head Unit | |
| Bluetooth Device→SP→Command→Head | Bluetooth Device |
| Head Unit, | |
| SP→RTP (Audio) →Head Unit | |
| or | |
| Head Unit→RTP (Video) →SP | |

Obviously, the car A/V system for wireless communication application of the present invention employs a wireless signal to connect the head unit 1 and the smart phone 2, eliminating complicated wiring and facilitating system installation. Further, the smart phone 2 that is normally attached to the head unit can be carried out of the car by the user for use independently. Further, a tablet PC with a wireless communication may be relatively larger in size than a smart phone, however, it can still be used in the car A/V system for wireless communication application to substitute for the smart phone.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A car A/V system for wireless communication application, comprising:
a head unit installed in a car comprising a vehicle control computer system, said head unit being electrically connected to said vehicle control computer system through a CAN-bus for transmitting audio and video data therebetween, said head unit comprising a first wireless communication module and a multimedia processing device, said multimedia processing device being adapted to process audio and video data from different sources;
at least one smart phone, each said smart phone comprising a display means and a second wireless communication module for communication with said first wireless communication module wirelessly, said display means comprising a touch panel; and
a speaker system installed in said car and electrically connected to said head unit;
wherein the touch panel of each said smart phone is operable to generate a command that is transmittable to said multimedia processing device of said head unit wirelessly through the second wireless communication module of the respective smart phone and said first wireless communication module of said head unit to run a predetermined audio/video data, enabling the video data to be transmitted to the respective smart phone wirelessly for display on the display means of the respective smart phone and the audio data to be transmitted to said speaker system for output.

2. The car A/V system for wireless communication application as claimed in claim 1, wherein the second wireless communication module of each said smart phone and said first wireless of said head unit are Wi-Fi modules.

3. The car A/V system for wireless communication application as claimed in claim 1, wherein said head unit and said at least one smart phone are adapted for wireless communication subject to real-time transport protocol.

4. The car A/V system for wireless communication application as claimed in claim 1, further comprising a charger electrically connectable to each said smart phone through a USB cable.

5. The car A/V system for wireless communication application as claimed in claim 1, wherein said multimedia processing device is configured to process audio/video files from CD, DVD, SD memory card and/or USB.

6. The car A/V system for wireless communication application as claimed in claim 1, wherein said multimedia processing device is configured to process DVB-T (Digital Video Broadcasting-Terrestrial) signals.

7. The car A/V system for wireless communication application as claimed in claim 1, wherein said head unit further comprises a GPS sensor.

8. The car A/V system for wireless communication application as claimed in claim 1, wherein said multimedia processing device is configured to process FM/AM broadcasting signals.

9. The car A/V system for wireless communication application as claimed in claim 1, wherein said head unit further comprises a rear camera.

10. The car A/V system for wireless communication application as claimed in claim 1, wherein said head unit further comprises a digital video recorder.

11. The car A/V system for wireless communication application as claimed in claim 1, wherein said head unit further comprises an AUX-in connector.

12. The car A/V system for wireless communication application as claimed in claim 1, wherein each said smart phone has a Bluetooth function for communication with an external Bluetooth device.

13. The car A/V system for wireless communication application as claimed in claim 1, wherein each said smart phone comprises a GPS module.

14. The car A/V system for wireless communication application as claimed in claim 1, wherein each said smart phone is equipped with a 3.5G/4G wireless mobile phone and data transmission system for cloud computing based vehicle tracking and fleet management and dispatch management, said 3.5G/4G wireless mobile phone and data transmission system having built therein a GPS system.

15. The car A/V system for wireless communication application as claimed in claim 1, wherein said head unit comprising:
a user interface disposed at an outer side thereof for operation by a user;
a microcontroller unit;
a video switch mixer electrically connected to said microcontroller unit;
a volume switch control electrically connected to said microcontroller unit for controlling said speaker system; and
a power management electrically connected to said microcontroller unit and adapted for obtaining power supply from a power supply system of said car.

16. The car A/V system for wireless communication application as claimed in claim 15, wherein said user interface comprises at least one control button.

17. A car A/V system for wireless communication application, comprising:
a head unit installed in a car comprising a vehicle control computer system, said head unit being electrically connected to said vehicle control computer system through a CAN-bus for transmitting audio and video data therebetween, said head unit comprising a first wireless communication module and a multimedia processing device, said multimedia processing device being adapted to process audio and video data from different sources;
at least one tablet computer, each said tablet computer comprising a display means and a second wireless communication module for communication with said first wireless communication module wirelessly, said display means comprising a touch panel; and
a speaker system installed in said car and electrically connected to said head unit;
wherein the touch panel of each said tablet computer is operable to generate a command that is transmittable to said multimedia processing device of said head unit wirelessly through the second wireless communication module of the respective tablet computer and said first wireless communication module of said head unit to run a predetermined audio/video data, enabling the video data to be transmitted to the respective tablet computer wirelessly for display on the display means of the respective tablet computer and the audio data to be transmitted to said speaker system for output.
